(19) United States
(12) Patent Application Publication
(10) Pub. No.: US 2007/0180379 A1
(43) Pub. Date: Aug. 2, 2007

(54) Virtual desktop in handheld devices

(76) Inventor: Jerold Osato, Pinole, CA (US)

Correspondence Address: MATTHEW E. BURR;LAKE AUSTIN MARINA, 2219 WESTLAKE DR, STE 200, AUSTIN, TX, 78746, US

(21) Appl. No.: 11/346,602

(22) Filed: Feb. 2, 2006

(51) Int. Cl. G06F 3/00

(52) U.S. Cl. 715/703

(57) ABSTRACT

To overcome the physical limitation of the display screen size, some computing devices may use the display screen as a window to show a subset of a larger “virtual desktop”. For example, a laptop with an 800×600 pixel display may show a subset of a 1280×1024 pixel virtual desktop. The user then manipulates scrollbars on the sides of the display to move the window to the portion of the virtual desktop he wishes to view. The display screen may pose a particular problem for personal digital assistants (PDAs), cell phones, and other handheld devices which have relatively small displays. A hand held device of the present disclosure is its own mouse, such that a virtual desktop may be navigated by moving the device itself to display desired portions of the virtual desktop on the screen of the device.

### FIELD OF THE DISCLOSURE

The present disclosure relates to electronic devices, and in particular to machines, methods and machine-readable media to facilitate the use and navigation of a virtual desktop on a handheld device such as a Personal Digital Assistant (PDA).

### BACKGROUND

A handheld computing device such as a PDA, or a communications terminal such as a cell phone, may have a small display screen whose size is limited by the constraints of portability. A small display may only show a limited amount of information in a single window. Higher resolution may compensate but at the expense of text being too small to read.

“Virtual desktop” is a term used, usually within the WIMP (window, icon, menu, and pointing device) paradigm, to describe any one of several possible ways known to those skilled in the art in which a computer's metaphorical desktop environment, as displayed on the screen, may be modified through the use of software. A virtual desktop, however, may exceed the capability of a small screen to display the full content of the virtual desktop. Excessive and annoying scrolling with small control elements may be necessary to access all of the virtual desktop content.

### BRIEF DESCRIPTION OF THE DRAWINGS

The detailed description that follows, by way of non-limiting examples of embodiments, makes reference to the noted drawings in which reference numerals represent the same parts throughout the several views of the drawings, and in which:

FIG. 1A is an isometric illustration of the front side 112 of an exemplary embodiment of a handheld device 110 of the present disclosure.

FIG. 1B is an illustration of the back or underside 114 of an exemplary embodiment of a device 110 of FIG. 1A.

FIG. 2 is an illustration of the back or underside 114 of an exemplary alternative embodiment of a PDA device 110 of the present disclosure.

FIG. 3A is an isometric illustration of an exemplary embodiment of a handheld device of the present disclosure at an initial location.

FIG. 3B is an isometric illustration of an exemplary embodiment of the handheld device of FIG. 3A at a subsequent location to the initial location.

FIG. 4 is a process flow of an exemplary embodiment of a method of the present disclosure.

FIG. 5 is a diagrammatic representation of a machine in the form of a computer system 500 within which a set of instructions, when executed, may cause the machine to perform any one or more of the methodologies of the present disclosure.

### DETAILED DESCRIPTION

In view of the foregoing, through one or more various aspects, embodiments and/or specific features or sub-components, the present disclosure is thus intended to bring out one or more of the advantages that will be evident from the description. The present disclosure is makes reference one or more specific embodiments by way of illustration and example. The terminology, examples, drawings and embodiments, it is understood, are illustrative and are not intended to limit the scope of the disclosure.

In addition to what may be provided by a computer's physical hardware display, virtual desktops provide a “virtual” space in which a user can place his or her application windows. The trade-off for what is essentially extra (or virtual) space is that not all of the available space may be visually displayed at one time, or the quality of the display might be compromised in some way.

To overcome the physical limitation of the display screen size, some computing devices may use the display screen as a window to show a subset of a larger “virtual desktop”. For example, a laptop with an 800×600 pixel display may show a subset of a 1280×1024 pixel virtual desktop. The user then manipulates scrollbars on the sides of the display to move the window to the portion of the virtual desktop he wishes to view. The amount of scrolling becomes more pronounced as the differential between the real screen resolution and the resolution of the virtual desktop increases.

The same input device (mouse, optical mouse, track ball, trackpad, stylus, and so forth) used for moving the window by manipulating the scrollbars may also used for the selection, movement, or other manipulation of objects on the desktop. The coupling of two functions in the same input device may limit efficiency. Repeatedly shifting paradigms between movement of the screen and movement of objects on the screen may become annoying and tiresome. It may also lead to work errors or system crashes if the operating system of the device is not sufficiently robust to tolerate rapid or frequent changes in the operating mode of the device.

For some handheld devices or machines, the coupling issue is exaggerated because the typical small size of the display may force more scrolling. A typical PDA display resolution may be 240×320 pixels. The miniaturization of the input device (often forced to combine of multiple functions as well) may make fine movement problematic and make it more difficult to select or scroll.

To make movement around a virtual desktop on a PDA easier, the present disclosure describes using movement of the PDA itself to move the window around a virtual desktop instead of manipulating a conventional control element on the device or on the PDA display. On the underside of the PDA an optical pickup, for example, may sense the movement of the device relative to the surface it is resting on in a manner analogous to that of an optical mouse. The display window may then move over the virtual desktop in the corresponding direction of the movement of the device.

Actuating a push button or a combination push button/scroll wheel, for example, may serve to change modes between a fixed window and a moving window. Rotation of the push button/scroll wheel may zoom in and out from the virtual display.

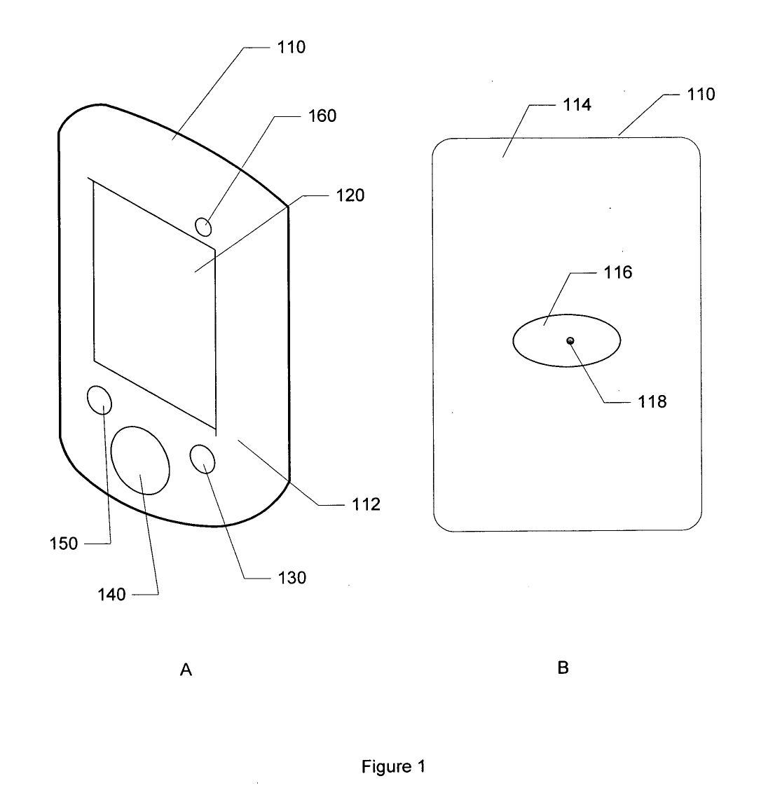

Turning now to the drawings, FIG. 1A is an isometric illustration of the front side 112 of an exemplary embodiment of a handheld device 110 of the present disclosure. Handheld device 110, such as for example a PDA, may include display screen 120, input or control elements 130, 140, 150 and 160. FIG. 1B is an illustration of the back or underside 114 of an exemplary embodiment of a device 110 of FIG. 1A. Optical sensor 118 is disposed in sensor housing 116.

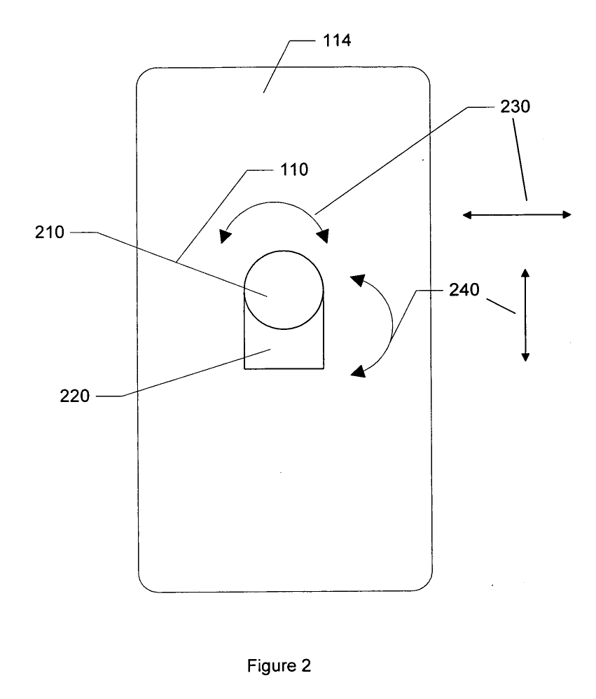

FIG. 2 is an illustration of the back or underside 114 of an exemplary alternative embodiment of a PDA device 110 of the present disclosure. An embodiment of FIG. 2 may have a combination trackball/mouse ball 210 on underside 114 of device 110. When handheld device 110 is on a surface, movement over the surface moves the display window. When handheld device 110 is not on a surface, the user may manipulate the trackball/mouse ball on underside 114 of handheld device 110 to accomplish the same objective. Such a method also may be used in small devices not constrained to a surface, such as for example digital cameras and cell phones.

Mouse or track ball 210 is disposed in ball housing 220, which translates horizontal motion 230 (also shown with a horizontal arrow off to the side) and vertical motion 240 (also shown with a vertical arrow off to the side) of PDA 110 to correspondingly move a virtual desktop window displayed on screen 120.

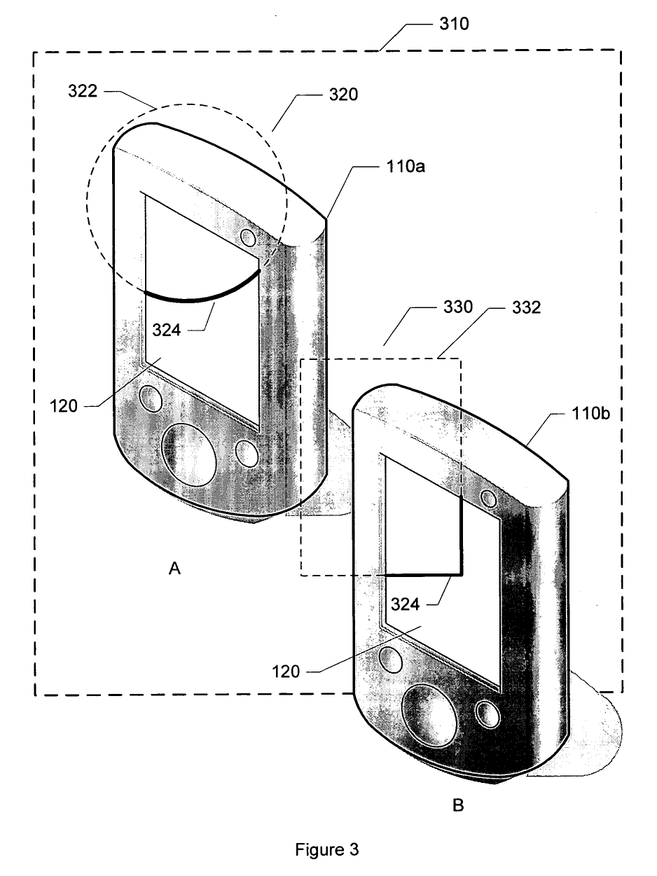

FIG. 3A is an isometric illustration of an exemplary embodiment of a handheld device of the present disclosure at an initial location 110a. A virtual desktop is represented by a dotted line rectangle 310. Elements 320 (circle), 330 (rectangle) on virtual desktop 310 may be, for example, desktop icons to launch an application, or a document, or an open application window. Display screen 120 is large enough to display only a portion of virtual desktop elements 310 and 320. In location 110a, element 320 is mostly off-screen, as depicted by the area described by dotted-line arc 322, while the portion described by bold-line arc 324 is displayed on screen 120.

FIG. 3B is an isometric illustration of an exemplary embodiment of the handheld device of FIG. 3A at a subsequent location 110b to the initial location 110a. Placing or moving device 110a to a different location 110b changes the portion of virtual desktop 310 that is display by screen 120. Element 320 is entirely off screen 120, as is the portion of element 330 described by dotted-line 332. The portion of element 320 described by bold-lined corner 324 is displayed by screen 120.

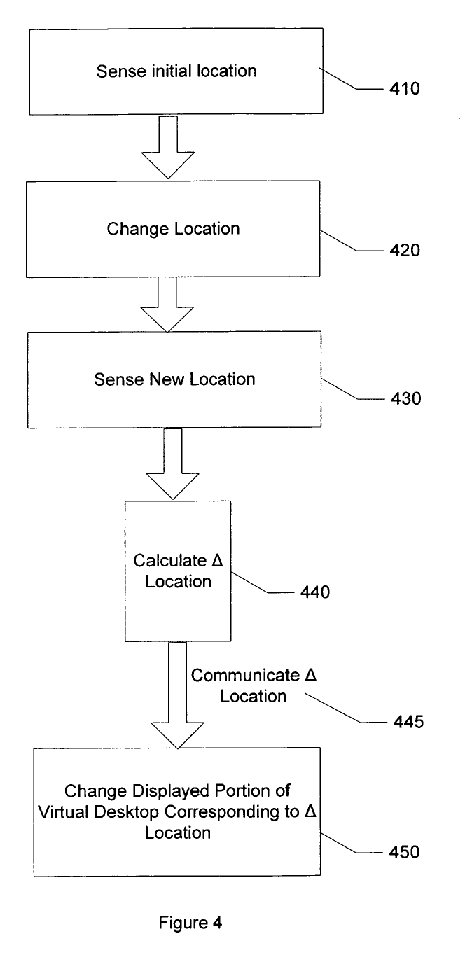

FIG. 4 is a process flow of an exemplary embodiment of a method of the present disclosure. A method of the present disclosure may include, but is not necessarily limited to, sensing the initial location 410 of a device 110, changing the location 420 of device 110, sensing the new location 430 of device 110, calculating the change (delta:Δ) in location 440, and changing 450 the portion of a virtual desktop displayed on a screen of a handheld device corresponding to the change in location of the handheld device. A method of the present disclosure may further include communicating the calculated change in location from sensor 118/220 (or perhaps more precisely from the memory address of the Δ result) to the display screen of handheld device 110.

Due to the variety of means which may be employed to detect the change in location of the handheld device of the present disclosure, the location may be referred to herein as the “detected” location. For instance, using a finger or hand to manipulate a mouse or track ball to mimic the movement of the handheld device on a surface will not change the physical location of the handheld device, but will change the detected or apparent location of the device from an initial detected location. It will be understood, however, that a detected location may, of course, be an actual physical location so that the term “detected” may be defined as being inclusive of, but not limited to, a physical location.

In addition to the location input devices discussed so far, other location detectors or sensors may also be contemplated by the present disclosure. For example, a 2- or 3-axis accelerometer position sensor may sense changes in the rotational position, or the position in three dimensions, of the handheld device such that a virtual desktop may be navigated by moving the handheld device in the air. Another example may be a global positioning satellite (GPS) system in the handheld device. A sufficiently discriminating GPS device may detect changes in location in both two-dimensional and three-dimensional motion. Accordingly, the term “location” may also be defined as being inclusive of, but not limited to, two-dimensional and three-dimensional detected or apparent location, and detected rotational position.

Among the handheld devices that may find a virtual desktop navigation system of the present disclosure advantageous may be a Personal Digital Assistant (PDA), a cell phone, a digital music player, a portable video game device, a digital video player, a digital camera and so forth. PDA may include such devices as a Palm Pilot®- or Trio®-type device, or a Blackberry®-type device. Certain laptop- or notebook-type personal computers may also be contemplated by the present disclosure.

Embodiments of the present disclosure may advantageously “decouple” the necessity of using a small and somewhat limited input device of the handheld for multiple purposes. For example, moving the display may be decoupled from the selection and movement of objects on the virtual desktop using the same control element.

A further advantage is that the control command input element may be large and easy to manipulate because the input device becomes the PDA itself. In effect the entire PDA is acting as a mouse to move the display around the virtual desktop, freeing the conventional input to be dedicated to the function of movement and selection of objects on the desktop.

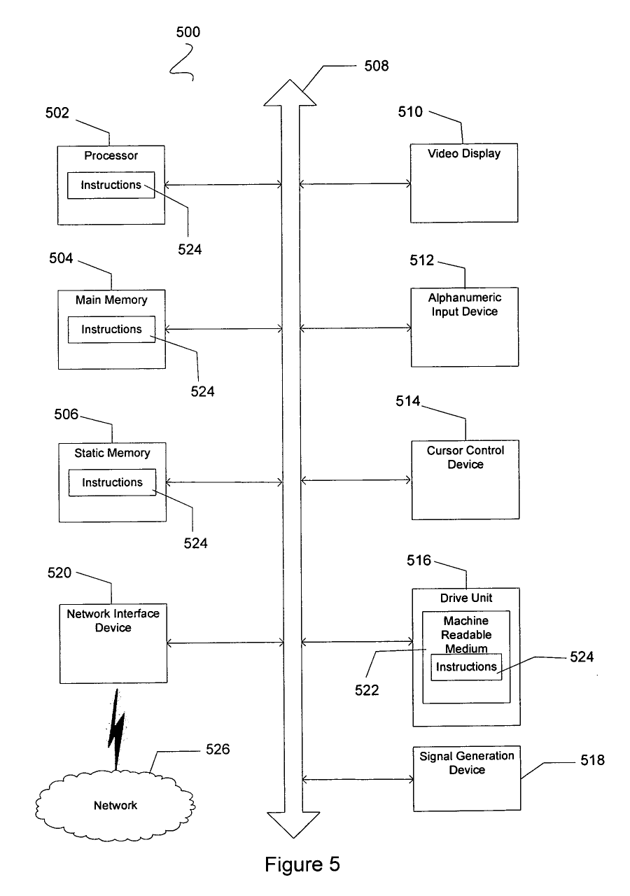

In accordance with various embodiments of the present disclosure, the methods described herein are intended for operation as software programs running on a programmable machine such as a computer processor. FIG. 5 is a diagrammatic representation of a machine in the form of a computer system 500 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU), or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse, optical mouse, track ball, trackpad, stylus and the like), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated in herein above. The instructions 524 may also reside, completely or at least partially, within the main memory 504, the static memory 506, and/or within the processor 502 during execution thereof by the computer system 500. The main memory 504 and the processor 502 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of embodiments as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. The disclosure is considered to include a tangible storage medium or distribution medium, including a propagated signal, as listed herein and including art-recognized equivalents and successor media, in which the software implementations herein are stored.

Those skilled in the art will recognize that the present disclosure extends to machine-readable media (“MRM”) contain instructions for execution by a programmable machine such as a computer. MRM is broadly defined to include any kind of computer memory such as floppy disks, conventional hard disks, CD-ROMs, Flash ROMS, nonvolatile ROM, RAM, Storage Media, email attachments, solid state media, magnetic media, and signals containing instructions, together with processors to execute the instructions.

The term “machine-readable medium” shall accordingly be taken to further include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus the following claims are hereby incorporated into the Detailed Description, with each claim standing on its own as a separate embodiment.

The description has made reference to several exemplary embodiments. It is understood, however, that the words that have been used are words of description and illustration, rather than words of limitation. Changes may be made within the purview of the appended claims, as presently stated and as amended, without departing from the scope and spirit of the disclosure in all its aspects. Although description makes reference to particular means, materials and embodiments, the disclosure is not intended to be limited to the particulars disclosed; rather, the disclosure extends to all functionally equivalent technologies, structures, methods and uses such as are within the scope of the appended claims.

I claim:

1. A handheld device having a display screen, the device comprising:
an input device in communication with the display screen and adapted to sense, relative to a detected initial location of the handheld device, a change in the detected location of the handheld device; and
a virtual desktop window adapted for display on the display screen, wherein the perimeter dimensions of the virtual desktop window exceed the perimeter dimensions of the display screen such that at least one portion of the virtual desktop window is not displayed on the display screen and another portion of the virtual desktop window is displayed on the display screen;
wherein the displayed portion of the virtual desktop window changes in response to a change in the detected location of the handheld device.

2. The handheld device of claim 1, wherein the input device comprises an optical sensor.

3. The handheld device of claim 1, wherein the input device comprises a mouse ball.

4. The handheld device of claim 1, wherein the input device comprises a scroll wheel.

5. The handheld device of claim 1, wherein the input device comprises a track pad.

6. The handheld device of claim 1, wherein the input device comprises an accelerometer position sensor.

7. The handheld device of claim 1, wherein the input device comprises a global positioning satellite (GPS) system.

8. The handheld device of claim 1, further comprising a front side housing the display screen, and a back side posterior to the front side, the input device being housed in the backside of the handheld device.

9. The handheld device of claim 1, further comprising a machine-readable medium containing instructions that, when executed by a machine of the handheld device, the instructions cause the handheld device to change the displayed portion of the virtual desktop window in response to a change in the detected location of the handheld device.

10. The handheld device of claim 1, further comprising a second input device for manipulating elements of the virtual desktop.

11. The handheld device of claim 10, further comprising a third input device for manipulating elements of the display screen.

12. The handheld device of claim 1, further comprising a second input device for manipulating elements of the display screen.

13. A handheld device having a display screen, the device comprising:
a first input device in communication with the display screen and adapted to sense, relative to a detected initial location of the handheld device, a change in the detected location of the handheld device;
a virtual desktop window adapted for display on the display screen, wherein the perimeter dimensions of the virtual desktop window exceed the perimeter dimensions of the display screen such that at least one portion of the virtual desktop window is not displayed on the display screen and another portion of the virtual desktop window is displayed on the display screen;
a front side housing the display screen;
a back side posterior to the front side and housing the first input device;
a second input device to manipulate elements of the virtual desktop window; and
a machine-readable medium containing instructions that, when executed by the handheld device, the instructions cause the handheld device to change the displayed portion of the virtual desktop window in response to a change in the detected location of the handheld device.

14. The handheld device of claim 13, further comprising a third input device to manipulate elements of the display screen.

15. A method for using a virtual desktop window displayed on a display screen of a handheld device, wherein the perimeter dimensions of the virtual desktop window exceed the perimeter dimensions of the display screen such that at least one portion of the virtual desktop window is not displayed on the display screen and another portion of the virtual desktop window is displayed on the display screen; the method comprising:
sensing, relative to a detected initial location of the handheld device, a change in the detected location of the handheld device; and
changing the displayed portioned of the virtual desktop window in response to the change in the detected location of the handheld device.

16. The method of claim 15, further comprising calculating a change in the detected position of the handheld device.

17. The method of claim 16, further comprising changing a displayed portion of the virtual desktop window corresponding to the calculated change in the detected position of the handheld device.

18. The method of claim 15, further comprising changing the detected location of the handheld device by changing the physical location of the handheld device.

19. The method of claim 15, further comprising changing the detected location of the handheld device by actuating a location sensor of the handheld device.

20. The method of claim 15, further comprising bringing an element of the virtual desktop window into view on the display screen by changing the detected location of the handheld device.

21. The method of claim 20, further comprising manipulating the element of the virtual desktop window.

22. A machine-readable medium containing instructions that, when executed by a handheld machine having a location sensor, the handheld machine being adapted to display a virtual desktop window on a display screen of the handheld machine, wherein the perimeter dimensions of the virtual desktop window exceed the perimeter dimensions of the display screen such that at least one portion of the virtual desktop window is not displayed on the display screen and another portion of the virtual desktop window is displayed on the display screen, the instructions cause the handheld machine to change the displayed portion of the virtual desktop window in response to a change in the detected location of the handheld machine.

23. The medium of claim 22, wherein the instructions cause the handheld machine to:
calculate a change in the detected position of the handheld machine;
communicate the calculated change in detected position to the handheld machine; and
change a displayed portion of the virtual desktop window corresponding to the calculated change in the detected position of the handheld machine.

24. The medium of claim 22, wherein the handheld machine comprises a Personal Digital Assistant (PDA).

25. The medium of claim 22, wherein the handheld machine comprises a Blackberry®-type device.

26. The medium of claim 22, wherein the handheld machine comprises a cell phone.

27. The medium of claim 22, wherein the handheld machine comprises a digital music player.

28. The medium of claim 22, wherein the handheld machine comprises a digital video player.

29. The medium of claim 22, wherein the location sensor comprises a position sensor, wherein the change in the detected position comprises a change in the rotational position of the handheld machine.

30. The medium of claim 22, wherein the detected position of the handheld machine is the physical location of the handheld device.
